(19) United States
(12) Patent Application Publication
(10) Pub. No.: US 2005/0007902 A1
(43) Pub. Date: Jan. 13, 2005

(54) Optical disk reproducing device

(75) Inventor: Atsuo Hosoi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/879,193

(22) Filed: Jun. 30, 2004

(30) Foreign Application Priority Data
Jul. 11, 2003 (JP) 2003-195993

(51) Int. Cl. G11B 7/00

(52) U.S. Cl. 369/44.27; 369/44.29; 369/44.35

(57) ABSTRACT

An optical disk reproducing device provided with servo automatic adjustment means for automatically performing an adjustment of setting an operation criterion to a servo mechanism, and also provided with an inner switch as pickup position detection means for detecting whether an optical pickup is at the inner track portion or the outer track portion of the optical disk and automatic adjustment determination means for determining whether or not a servo automatic adjustment is to be performed, the optical disk reproducing device is made such that the adjustment by the servo automatic adjustment means is not performed but the reproducing of the optical disk 1 is started when the detected position of the optical pickup is at the outer track portion at the time of re-starting of reproducing of the optical disk.

### BACKGROUND OF THE INVENTION

1. Field of the Invention

The present invention relates to an optical disk reproducing device provided with servo automatic adjusting means for automatically adjusting a servo mechanism to an adequate state.

2. Description of the Related Art

An optical disk reproducing device that irradiates an optical disk with laser light from an optical pickup to read information from the optical disk, can be stably operated under a servo mechanism such as a focus servo mechanism and a tracking servo mechanism.

In order to accomplish this servo mechanism function in an adequate state, it is necessary to perform a servo adjustment for absorbing variations in optical characteristics of the optical pickup and the optical disk and the effects of temperature in environment before the reproducing of the optical disk is started. In recent years, this servo adjustment is automatically performed.

As the main contents of this servo adjustment, it includes the canceling of offset for focusing and tracking, a balance adjustment, a gain adjustment and the like.

At this point, the servo automatic adjustment is performed when the optical disk is newly inserted and when the reproducing of the optical disk is again started (hereinafter it is referred to as “re-start”) after the reproducing of the optical disk is once stopped.

In a conventional optical disk reproducing device in the related art, the servo automatic adjustment is performed irrespective of a position of the optical pickup with respect to the optical disk, that is, in a case where the optical pickup is at the inner tracks of the optical disk and in a case where the optical pickup is at the outer tracks of the optical disk (for example, see patent document 1).

In this respect, when the optical disk is newly inserted, the optical pickup is then moved to the innermost track of the optical disk so as to read a lead-in area. Therefore, the servo automatic adjustment can be performed near the inner tracks of the optical disk when the optical pickup is moved to the innermost tracks. [Patent Document 1] Japanese Unexamined Patent Publication No. 7-320272

Since the conventional optical disk reproducing device in the related art is made in the manner described above, the servo automatic adjustment is performed also in a case where the optical pickup is at the outer tracks of the optical disk. As a result, the servo automatic adjustment is performed under conditions that a surface waving component of the optical disk and a skew component caused by a lens floatation due to an inclination of the optical disk, are generated in large amounts to cause deviations to the result of adjustment to be actually performed, which produces effects on the performance of reproducing the optical disk and presents problems of reducing performance of resistance to vibrations and playability.

### SUMMARY OF THE INVENTION

The present invention has been made to solve the problems described above. The object of the present invention is to provide an optical disk reproducing device that avoids performing a servo automatic adjustment under bad conditions and performs the adjustment in high accuracy to make no bud effect on the performance characteristics of reproducing an optical disk and to prevent resistance for vibrations and a playability as reproducing capability to a stain or scratch of the optical disk from changing for the worse side.

An optical disk reproducing device in accordance with the present invention includes: pickup position detection means that detects whether an optical pickup is at an inner track portion or an outer track portion of the optical disk; and automatic adjustment determination means that directly reproduces the optical disk in a case where a position of the optical pickup detected by the pickup position detection means is at the outer track portion when re-starting detection means detects that the optical disk is re-started.

Therefore, according to the present invention, it is possible to avoid performing the servo automatic adjustment when the optical pickup is at the outer track portion, that is, when the servo mechanism might be inaccurately set under bad conditions and to prevent the performance capability of reproducing the optical disk, resistance to vibrations, and playability from changing for the worse side.

### BRIEF DESCRIPTION OF THE DRAWINGS

FIG. 1 is a schematic diagram of an optical disk reproducing device in accordance with embodiment 1 of the present invention.

FIG. 2 is a flow chart of a servo automatic adjustment when an optical disk is newly inserted in the optical disk reproducing device of embodiment 1 of the present invention.

FIG. 3 is a flow chart of a servo automatic adjustment when the optical disk reproducing device is re-started in the optical disk reproducing device of embodiment 1 of the present invention.

FIG. 4 is a flow chart of a servo automatic adjustment when an optical disk reproducing device is re-started in an optical disk reproducing device in accordance with embodiment 2 of the present invention.

FIG. 5 is a schematic diagram of an optical disk reproducing device in accordance with embodiment 3 of the present invention.

FIG. 6 is a flow chart of a servo automatic adjustment when the optical disk reproducing device is re-started in the optical disk reproducing device of embodiment 3 of the present invention.

FIG. 7 is a schematic diagram of an optical disk reproducing device in accordance with embodiment 4 of the present invention.

FIG. 8 is a flow chart of a servo automatic adjustment when the optical disk reproducing device is re-started in the optical disk reproducing device of embodiment 4 of the present invention.

### DETAILED DESCRIPTION OF THE PREFERRED EMBODIMENTS

Hereafter, the preferred embodiments of the present invention will be described.

Embodiment 1

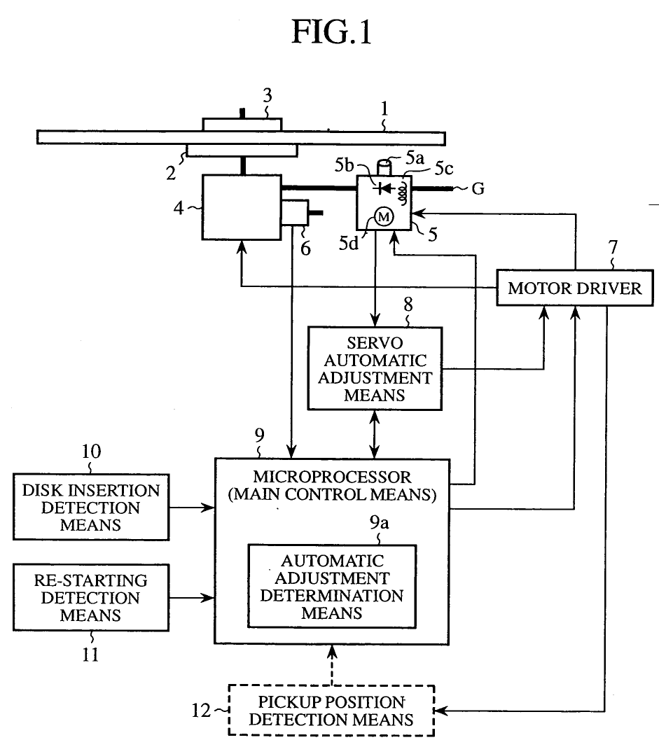

FIG. 1 is a schematic diagram of an optical disk reproducing device in accordance with embodiment 1 of the present invention.

In FIG. 1, an optical disk reproducing device is composed of mechanical parts of a turntable 2 for setting an optical disk 1, a damper 3, a spindle motor 4 and the like, electrical parts of an optical pickup 5 and an inner switch 6 as pickup position detection means for detecting whether the optical pickup 5 is at the inner tracks or at the outer tracks of the optical disk, and electric circuit parts of a motor driver 7, a servo automatic adjustment means 8, a microprocessor (main control means) 9, a disk insertion detection means 10, re-starting detection means 10 and the like.

Here, the position of optical pickup 5 may be detected by pickup position detection means 12 (which will be described later) instead of the inner switch 6.

At this point, a servo mechanism is structured of the motor driver 7 operated under control mainly performed by the microprocessor 9 as main control means and the spindle motor 4 and the optical pickup 5 operated under control of the motor drive 7.

At this point, the optical disk 1 is set on the turntable 2 and is pressed by the damper 3 from above and fixed on the turn table 2.

The spindle motor 4 rotates the turntable 2.

The optical pickup 5 includes an objective lens 5a, a laser diode 5b for emitting laser light, a drive coil 5c for driving the objective lens 5a in a vertical direction and the like, and a motor 5d for moving the optical pickup 5 between the inner tracks and the outer tracks of the optical disk.

The optical disk 1 is irradiated with laser light emitted from the laser diode 5b and various kinds of servo signals and signals of sound and image are detected from the returned light (reflected light) of this irradiation.

Moreover, the optical pickup 5 is moved along a guide G between the outer tracks and the inner tracks of the optical disk 1 by the built-in motor 5d.

The inner switch 6 is pickup position detection means and is pushed by the optical pickup 5 when it comes to the innermost track of the optical disk 1 to output a pickup position detection signal showing that the optical pickup 5 is at the innermost track of the optical disk 1.

The motor driver 7 controls to rotate the spindle motor 4 and the motor 5d built in the optical pickup 5.

The servo automatic adjustment means 8 automatically performs an adjustment of setting an operation criterion to the servo mechanism at a step before the reproducing of the optical disk 1 so that the servo mechanism adequately operates at the time of reproducing the optical disk 1.

The microprocessor 9 controls the servo mechanism of the device via the motor driver 7, the servo automatic adjustment means 8 and the like. This microprocessor 9 has, as one of its functions, automatic adjustment determination means 9a for determining whether or not the servo automatic adjustment is to be performed.

The disk insertion detection means 10 detects that the optical disk 1 is inserted.

The re-starting detection means 11 detects that the reproducing of optical disk 1 is started and then stopped and again started (this timing is hereinafter referred to as “at the time of re-starting”).

Next, the servo automatic adjustment performed by the servo automatic adjustment means 8 will be described.

The servo automatic adjustment is an adjustment of setting the operation criterion to the servo mechanism at a step before the reproducing of optical disk 1, as described above. After the servo mechanism undergoes this adjustment, the optical disk 1 can be reproduced in normal fashion.

The main contents of this adjustment include the canceling of offset for focusing and tracking, a balance adjustment, a gain adjustment and the like.

In a case of performing the servo automatic adjustment, the optical disk 1 is irradiated with laser light from the optical pickup 5. The optical pickup 5 receives return light (reflected light) by this irradiation and the return light is converted to an electric signal by an optoelectronic circuit (not shown) and the electric signal is sent to the servo automatic adjustment means 8.

The servo automatic adjustment means 8 generates various kinds of servo signals such as focus error, tracking error, and signal components (RF waves) of sound and image on the basis of the input electric signal of return light and sends them to the microprocessor 9.

The microprocessor 9 observes the various kinds of input servo signals and gives an instruction of servo adjustment to the servo automatic adjustment means 8.

The servo automatic adjustment means 8 complies with the instruction from the microprocessor 9 to control the motor built in the optical pickup 5 via the motor driver 7 to adjust the canceling of offset for focusing and tracking and the like.

Moreover, the servo automatic adjustment means 8 adjusts also the gain and balance of related circuits such as an amplification circuit (not shown) and the like. Because there is difference in detection sensitivity between sensors in the detectors at the time of detecting various kinds of signals from the optical disk 1, the adjustment of balance of the circuits is performed for a purpose of correcting the difference and bringing the detection sensitivities of sensors into a proportional state.

Variations in the optical characteristics of the optical disk 1 and the optical pickup 5 and the effects of temperature in environment are corrected by the above described automatic adjustment and hence the reproducing of the optical disk 1 is achieved thereafter in normal fashion under adequate servo mechanism.

Next, performing of the servo automatic adjustment will be described.

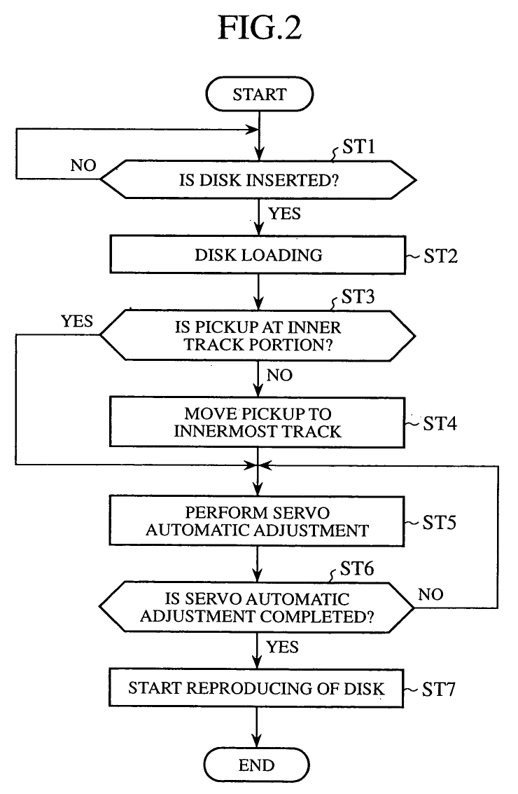

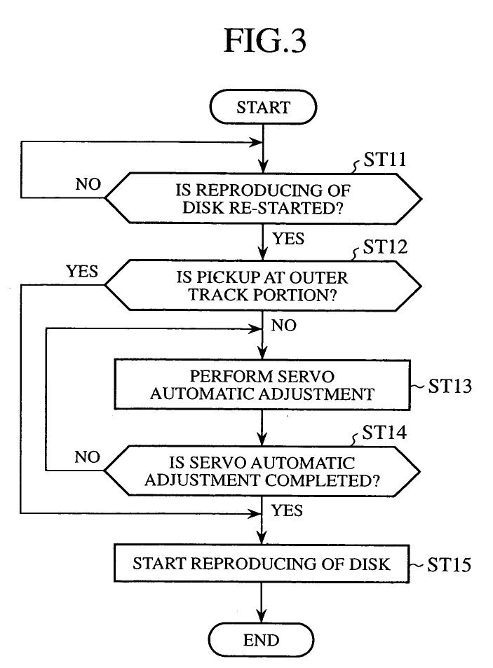

FIG. 2 is a flow chart of servo automatic adjustment when the optical disk 1 is newly inserted and FIG. 3 is a flow chart of servo automatic adjustment at the time of re-starting.

First, it will be described about FIG. 2.

When the optical disk 1 is newly inserted, the optical pickup 5 is then moved to the inner track side of the optical disk 1 to read information in a lead-in area recorded near the innermost track, so the servo automatic adjustment can be performed under conditions where the surface waving of the optical disk 1 is little. Hence, when the optical disk 1 is newly inserted, the servo automatic adjustment is performed in the conventional manner.

At step ST1, the microprocessor 9 determines on the basis of a detection signal from the disk insertion detection means 10 whether or not the optical disk 1 is inserted and when optical disk 1 has been inserted (when YES at step ST1), the routine proceeds to step ST2.

At step ST2, the optical disk 1 is loaded to be reproduced.

At step ST3, the automatic adjustment determination means 9a of the microprocessor 9 determines whether or not the optical pickup 5 is at the innermost track of the optical disk 1 (step ST3).

This determination of position of the optical pickup 5 is made by the presence or absence of a pickup position detection signal sent to the microprocessor 9 from the inner switch 6 (pickup position detection means) and when the microprocessor 9 does not obtain the signal, the optical pickup 5 is not at the innermost position (when NO at step ST3) and in this case, the routine proceeds to step ST4. On the other hand, when the microprocessor 9 obtains the signal, the optical pickup 5 is at the innermost track (when YES at step ST3) and in this case, the routine proceeds to step ST5.

At step ST4, the optical pickup 5 is moved to the innermost track.

This movement of the optical pickup 5 is accomplished as follows: the microprocessor 9 issues an instruction to the motor driver 7 via the servo automatic adjustment means 8; and the motor driver 7 drives the motor 5d built in the optical pickup 5 in accordance with the instruction.

This driving of the motor 5d moves the optical pickup 5 to the innermost track and when the optical pickup 5 has arrived at the innermost track, the optical pickup 5 pushes the inner switch 6. With this arrangement, a pickup position detection signal is sent from the inner switch 6 to the microprocessor 9 and the microprocessor 9 obtains the signal.

At step ST5, the servo automatic adjustment is performed by the servo automatic adjustment means 8. At step ST6, the automatic adjustment determination means 9a of the microprocessor 9 determines whether or not the servo automatic adjustment is completed.

In a case where the servo automatic adjustment is not completed (when NO at step ST6), the servo automatic adjustment at step ST5 is continued and when the servo automatic adjustment is completed (when YES at step ST6), the routine proceeds to step ST7. At step ST7, the reproducing of the optical disk 1 is started because the servo automatic adjustment is completed.

Next, it will be described about FIG. 3.

When the optical disk 1 is newly inserted, as described in FIG. 2, the servo automatic adjustment is performed at the inner track position of the optical disk 1.

However, there is a case where the reproducing of optical disk 1 is stopped after the servo automatic adjustment is completed and the reproducing of the optical disk 1 is started at step ST7 in FIG. 2. In such case the optical pickup 5 generally stops at a position where the reproducing is stopped without any returning action. At the time of re-starting, in the conventional optical disk reproducing device in the related art, the automatic adjustment is performed in a condition that the optical pickup is staying at the position where the reproducing of the optical disk 1 was stopped previously. As a result, there is presented a problem that the automatic adjustment will be probably performed even near the outer tracks where the surface waving of the optical disk 1 is large.

FIG. 3 shows a processing of an embodiment of the present invention to avoid the problem.

At step ST11, the microprocessor 9 determines on the basis of a detection signal from the re-starting detection means 11 whether or not reproducing of the optical disk 1 is re-started, and when the optical disk 1 is re-started (when YES at step ST11), the routine proceeds to step ST12. At step ST12, the automatic adjustment determination means 9a of microprocessor 9 determines whether or not the optical pickup 5 is at a position other than the innermost track (hereinafter the position other than the innermost track is referred to as “outer track portion”) of the optical disk 1.

This position determination method is the same as step ST3 in FIG. 2 and when the optical pickup 5 is not at the outer track portion, the routine proceeds to step ST13 and when the optical pickup 5 is at the outer track portion, the routine proceeds to step ST15. The following steps ST13, ST14, and ST15 are the same as the steps ST5, ST6, and ST7 in FIG. 2 and hence their descriptions will be omitted.

As described above in this embodiment 1, in a case where the optical pickup 5 is at the outer track portion at the time of re-starting, the servo automatic adjustment is not performed but the reproducing of the optical disk 1 is started as it is.

In FIG. 2 or FIG. 3 described above, the position of optical pickup 5 is detected on the basis of the signal from the inner switch 6 as the pickup position detection means.

In place of this structure, the position of the optical pickup 5 may be detected by the pickup position detection means 12 in FIG. 1.

This pickup position detection means 12 detects the position of the optical pickup 5 from a control data of the microprocessor 9 to the motor driver 7. Further alternatively, it is also recommended that the set information of a potentiometer which is built in the optical pickup 5, is obtained via the microprocessor 9 and that the position of the optical pickup 5 is detected from this set information.

In the following description the above described position determination at step ST3 (FIG. 2) or step ST12 (FIG. 3) is made by the automatic adjustment determination means 9a on the basis of this detection information by this pickup position detection means 12.

In a case where this pickup position detection means 12 is used, the pickup position detection means 12 can detect the position of the optical pickup 5 at any position within the range of movement of the optical pickup 5 and hence it can detect positions in minutely split manner when it is compared with the case of using the inner switch 6 which is capable of detecting only the position of the innermost track.

Hence, in a case where the pickup position detection means 12 is used, the innermost track is previously set with a predetermined range of tracks near by the innermost track (hereinafter the innermost track and tracks of its vicinity are referred to as “inner track portion”) in the automatic adjustment determination means 9a of the microprocessor 9 and the automatic adjustment determination means 9a determines at step ST3 in FIG. 2 or at step ST12 in FIG. 3 whether the optical pickup 5 is at the inner track portion or at a track other than the inner track portion (hereinafter the outer track portion is re-defined as a portion other than inner track portion)

When the term “innermost track” is construed as “inner track portion” in the embodiment in which the inner switch 6 is used, operation of an embodiment in which the pickup position detection means 12 is used, becomes quite the same, hence the description for the embodiment in which pickup position detection means 12 is used, is omitted.

As described above, according to this embodiment 1, at the time of re-starting of the optical disk 1, in a case where the optical pickup 5 is at the inner track portion, the servo automatic adjustment is performed and in a case where the optical pickup 5 is at the outer track portion, the servo automatic adjustment is not performed but the reproducing of the optical disk 1 is started as it is. Hence, it is possible to avoid performing the servo automatic adjustment at the outer track portion in which the servo mechanism might be set inaccurately under bad conditions and hence to prevent the performance capability of reproducing the optical disk 1, resistance to vibrations, and playability from changing for the worse side.

Embodiment 2

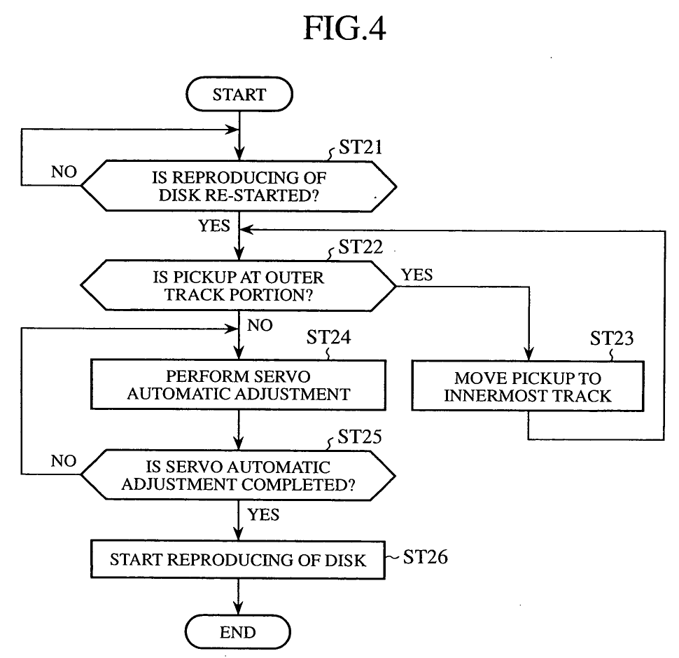

FIG. 4 is a flow chart of a servo automatic adjustment when an optical disk reproducing device is re-started in an optical disk reproducing device in accordance with embodiment 2 of the present invention, and it corresponds to FIG. 3 described in embodiment 1.

At this point, the schematic diagram of the optical disk reproducing device is the same as in embodiment 1 (FIG. 1) and the same parts are denoted by the same reference symbols.

At the time of re-starting of the optical disk 1, in embodiment 1 (FIG. 3), in a case where the optical pickup 5 is at the outer track portion, the servo automatic adjustment is not performed but the reproducing of the optical disk 1 is started.

In contrast to the embodiment 1, at the time of re-starting of the optical disk 1 in embodiment 2, it is made such that the optical pickup 5 is moved to the innermost track and then the servo automatic adjustment is performed, in a case where the optical pickup 5 is at the outer track portion.

That is, the reproducing of the optical disk 1 is re-started at step ST21 and in a case where it is determined at step ST22 that the optical pickup 5 is at the outer track portion of the optical disk 1, the routine proceeds to step ST23.

At step ST23, the optical pickup 5 is moved to the innermost track. This moving of the optical pickup 5 is performed in the same manner as at step ST4 in FIG. 2.

At this point, steps ST21, ST22, ST24, ST25, and ST26 other than step ST23 are the same as steps ST11, ST12, ST13, ST14, and ST15 in FIG. 3 and hence their descriptions will be omitted. In addition, also in this embodiment 2, the inner switch 6 in FIG. 1 may be used.

As described above, according to this embodiment 2, in the optical disk reproducing device provided with servo automatic adjustment means for automatically performing an adjustment of setting operation criterion to the servo mechanism, in a case where the optical pickup 5 is at outer track portion at the time of re-starting of the optical disk 1, this optical pickup 5 is moved to the innermost track and after it is moved there, the servo automatic adjustment is performed. Hence, the servo mechanism is correctly operated even at the time of re-starting of the optical disk 1 and hence it is possible to prevent the performance capability of reproducing the optical disk, resistance to vibrations and playability from changing for the worse side.

Embodiment 3

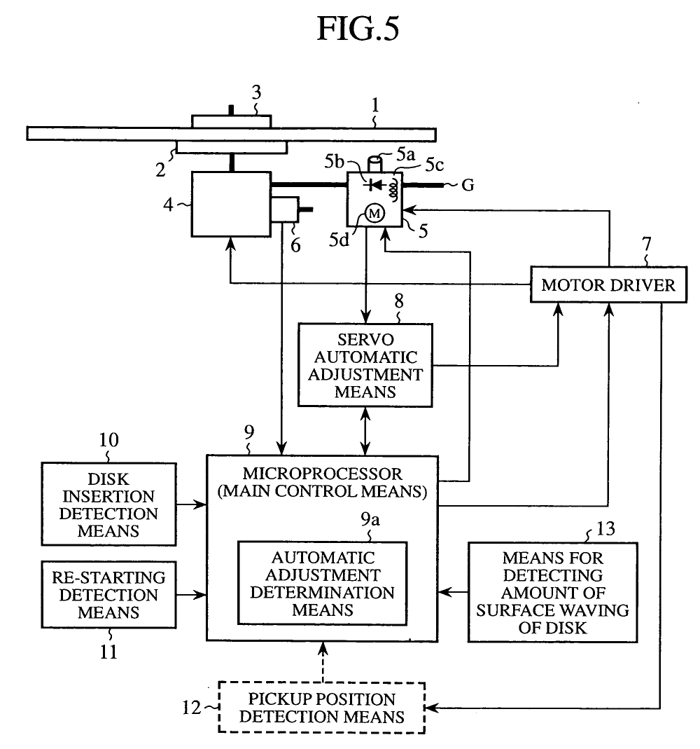

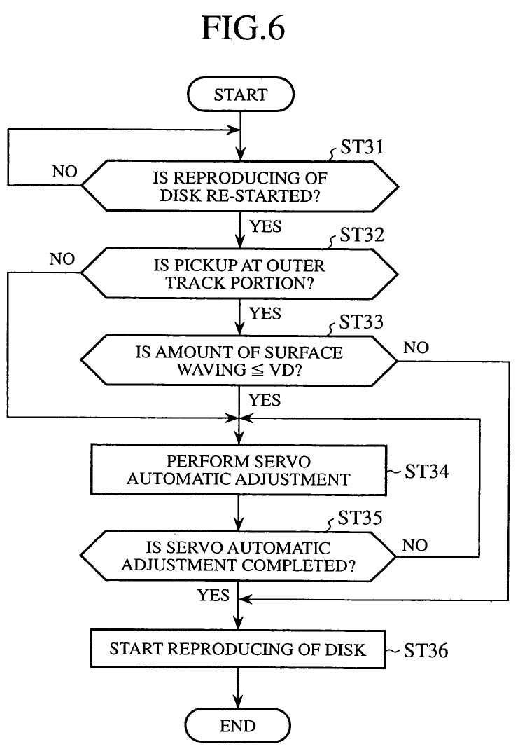

FIG. 5 is a schematic diagram of an optical disk reproducing device in accordance with embodiment 3 of the present invention. FIG. 6 is a flow chart of a servo automatic adjustment when the optical disk reproducing device is re-started in the optical disk reproducing device of embodiment 3 of the present invention. These FIG. 5 and FIG. 6 correspond to FIG. 1 and FIG. 3 described in embodiment 1.

In FIG. 5, the same parts as in FIG. 1 are denoted by the same reference symbols and it is means for detecting amount of surface waving of disk 13 that is different in the structure between FIG. 5 and FIG. 1.

In embodiment 1 described above, in a case where the optical pickup 5 is at the outer track portion at the time of re-starting, the servo automatic adjustment is not performed, and in embodiment 2, the optical pickup 5 is moved to the innermost track and the servo automatic adjustment is performed at this innermost track.

One of reasons for performing the servo automatic adjustment in these manner is that adequate adjustment cannot be performed at the outer track portion where the surface waving component of the optical disk 1 becomes large.

However, the amount of surface waving intrinsically differs between respective optical disks 1 and in a case where the amount of surface waving-of the optical disk 1 is small, there could be cases where the servo automatic adjustment can be performed even at the outer track portion.

It is this embodiment 3 that is made by taking note of this point, and in embodiment 3, the means for detecting amount of surface waving of disk 13 detects the amount of surface waving of the optical disk 1 and when the amount of detection is smaller than a criterion value, the servo automatic adjustment is performed even at the outer track portion.

The amount of surface waving of the optical disk 1 can be detected in the following manner.

The optical pickup 5 is provided with a drive coil 5c for generating a drive force to move the objective lens 5a in the vertical direction (a direction along which focusing is performed) and a waveform of voltage which is supplied to the drive coil 5c (lens driving voltage) is varied in response to a degree of surface waving of optical disk 1. In other words, the magnitude of variation in waveform of lens driving voltage shows an amount of the surface waving of the optical disk 1.

Hence, the means for detecting amount of surface waving of disk 13 obtains the information of waveform of lens driving voltage from the microprocessor 9 and detects the amount of surface waving on the basis of this information.

Hereafter, the servo automatic adjustment will be described with reference to FIG. 6.

At step ST31, the reproducing of the optical disk 1 is re-started and in a case where it is determined at step ST32 that the optical pickup 5 is at the outer track portion of optical disk 1, the routine proceeds to step ST33.

At step ST33, the means for detecting amount of surface waving of disk 13 detects the amount of surface waving and the automatic adjustment determination means 9a compares this detection result with a previously set criterion value (referred to as “VD”) (step ST33). In a case where the amount of surface waving is smaller than the criterion value VD in this comparison (when YES at step ST33), the routine proceeds to step ST34 where the servo automatic adjustment is performed, and in a case where the amount of surface waving is not smaller than the criterion value VD (when NO at step ST33), the routine proceeds to step ST36 where the reproducing of the optical disk 1 is started.

At this point, steps ST31, ST32, ST34, ST35, and ST36 other than step ST33 are the same as steps ST11, ST12, ST13, ST14, and ST15 in FIG. 3 and hence their descriptions will be omitted. In addition, also in this embodiment, the inner switch 6 in FIG. 1 may be used.

As described above, according to this embodiment 3, in a case where the optical pickup 5 is at the outer track portion at the time of re-starting of the optical disk 1, the amount of surface waving of the optical disk 1 is detected and when the amount of surface waving is smaller than the criterion value, the servo automatic adjustment is performed even at the outer track portion. Hence, the servo mechanism is correctly operated even at the time of re-starting of the optical disk 1, whereas the optical pickup 5 does not need to be moved to the innermost track, so the time required to re-start the reproducing of the optical disk 1 can be made shorter.

Embodiment 4

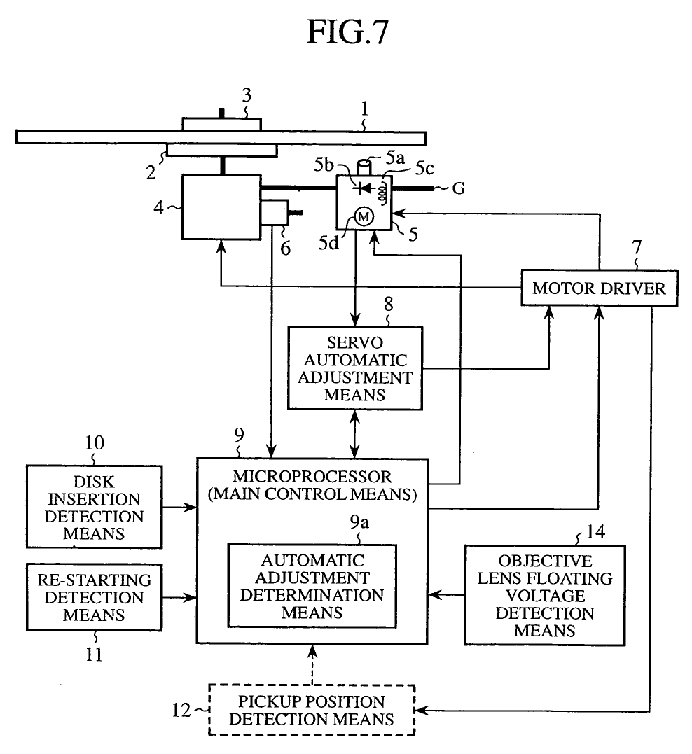

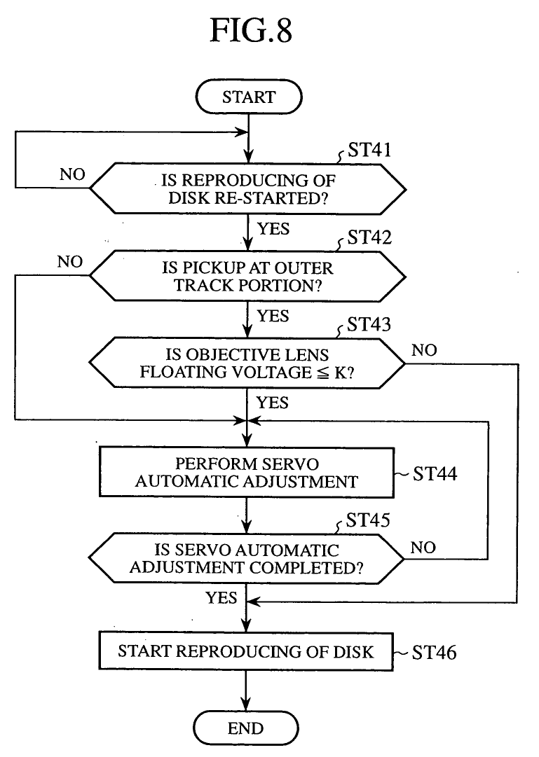

FIG. 7 is a schematic diagram of an optical disk reproducing device in accordance with embodiment 4 of the present invention. FIG. 8 is a flow chart of a servo automatic adjustment when the optical disk reproducing device is re-started in the optical disk reproducing device of embodiment 4 of the present invention. These FIG. 7 and FIG. 8 correspond to FIG. 1 and FIG. 3 described in embodiment 1.

In FIG. 7, the same parts as in FIG. 1 are denoted by the same reference symbols and it is objective lens floating voltage detection means 14 that is different in the structure between FIG. 7 and FIG. 1.

One of reasons for not performing the servo automatic adjustment at the outer track portion in a case where the optical pickup 5 is at the outer track portion at the time of re-starting of the optical disk 1, as described in embodiment 3, is that the amount of surface waving of the optical disk 1 becomes larger at the outer track portion.

Another reason is that the optical disk 1 is tilted by a tilt of shaft of the spindle motor 4 which rotates the turntable 2. This tilt of the optical disk 1 periodically makes a distance between the objective lens 5a and the optical disk 1 extremely large or small, whereby the objective lens 5a is floated, then a skew component is increased.

Effect by this tilt of the optical disk 1 becomes larger at the outer track of the optical disk 1.

At this point, the degree of tilt of the optical disk 1 can be detected in the following manner.

The above described magnitude of lens driving voltage for moving up and down the objective lens 5a relates to an amount of movement in the vertical direction of the objective lens 5a, and the amount of movement in the vertical direction of the objective lens 5a shows the degree of tilt of the optical disk For this reason, the objective lens floating voltage detection means 14 detects the lens driving voltage from the microprocessor 9 as an objective lens floating voltage.

At this point, the tilt of the optical lens 1 is intrinsically different between respective optical disk reproducing devices and in a case where the tilt of the optical disk 1 is small, there could be cases where the servo automatic adjustment can be performed even at the outer track portion.

It is this embodiment 4 that is made by taking note of this point, and in embodiment 4, the objective lens floating voltage detection means 14 detects the tilt of the optical disk 1 and when the amount of detection is smaller than a criterion value, the servo automatic adjustment is performed even at the outer track portion.

Hereafter, the servo automatic adjustment will be described with reference to FIG. 8.

At step ST41, the reproducing of the optical disk 1 is re-started and in a case where it is determined at step ST42 that the optical pickup 5 is at the outer track portion of the optical disk 1, the routine proceeds to step ST43. At step ST43, the objective lens floating voltage detection means 14 detects an objective lens floating voltage and the automatic adjustment determination means 9a compares this detection result with a previously set criterion value (referred to as “K”) (step ST43). In a case where the objective lens floating voltage is smaller than the criterion value K in this comparison (when YES at step ST43), the routine proceeds to step ST44 where the servo automatic adjustment is performed, and in a case where the objective lens floating voltage is not smaller than the criterion value K (when NO at step ST43), the routine proceeds to step ST46 where the reproducing of the optical disk 1 is started.

Here, steps ST41, ST42, ST44, ST45, and ST46 other than step ST43 are the same as steps ST11, ST12, ST13, ST14, and ST15 in FIG. 3 and hence their descriptions will be omitted. In addition, also in this embodiment, the inner switch 6 in FIG. 1 may be used.

As described above, according to this embodiment 4, in a case where the optical pickup 5 is at the outer track portion at the time of re-starting of the optical disk 1, the objective lens floating voltage is detected and when the objective lens floating voltage is smaller than the criterion value, the servo automatic adjustment is performed even at the outer track portion. Hence, the servo mechanism is correctly operated even at the time of re-starting of the optical disk 1, whereas the optical pickup 5 does not need to be moved to the innermost track, so the time required to re-start the reproducing of the optical disk 1 can be made shorter.

1. An optical disk reproducing device comprising:
a servo mechanism that moves an optical pickup between an inner track and an outer track of an optical disk whereas moves an objective lens built-in this optical pickup close to or away from the optical disk;
servo automatic adjustment means that automatically adjusts an operation criterion of the servo mechanism;
re-starting detection means for detecting that the reproducing of the optical disk is again re-started after the reproducing of the optical disk is stopped; and
main control means that controls the servo automatic adjustment means and the reproducing of the optical disk by the servo mechanism,
the optical disk reproducing device is characterized by further comprising:
pickup position detection means that detects whether the optical pickup is at the inner track portion or the outer track portion of the optical disk; and
automatic adjustment determination means that directly reproduces the optical disk in a case where a position of the optical pickup detected by the pickup position detection means is at the outer track portion when the re-starting detection means detects that the optical disk is re-started.

2. An optical disk reproducing device comprising:
a servo mechanism that moves an optical pickup between an inner track and an outer track of an optical disk whereas moves an objective lens built-in this optical pickup close to or away from the optical disk;
servo automatic adjustment means that automatically adjusts an operation criterion of the servo mechanism;
re-starting detection means for detecting that the reproducing of the optical disk is again re-started after the reproducing of the optical disk is stopped; and
main control means that controls the servo automatic adjustment means and the reproducing of the optical disk by the servo mechanism,
the optical disk reproducing device is characterized by further comprising:
pickup position detection means that detects whether the optical pickup is at the inner track portion or the outer track portion of the optical disk; and
automatic adjustment determination means that moves the optical pickup to the innermost track by the servo mechanism, in a case where a position of the optical pickup detected by the pickup position detection means is at the outer track portion when the re-starting detection means detects that the optical disk is re-started, and makes the servo automatic adjustment means perform a servo automatic adjustment at a position where the optical pickup is moved, and then reproduces the optical disk.

3. The optical disk reproducing device as claimed in claim 2, further comprising means for detecting amount of surface waving of disk that detects an amount of surface waving of the optical disk from a waveform variation in a lens driving voltage for moving up and down the objective lens, wherein the automatic adjustment determination means obtains information of the amount of surface waving of the optical disk from the disk surface waving detection means for detecting amount of surface waving of disk when the optical pickup is at the outer track portion, and makes the servo automatic adjustment means perform the servo automatic adjustment when the amount of surface waving of the optical disk is smaller than a criterion value.

4. The optical disk reproducing device as claimed in claim 2, further comprising objective lens floating voltage detection means that detects a lens driving voltage for moving up and down the objective lens as an objective lens floating voltage, wherein the automatic adjustment determination means obtains information of the objective lens floating voltage from the objective lens floating voltage detection means when the optical pickup is at the outer track portion, and makes the servo automatic adjustment means perform the servo automatic adjustment when the objective lens floating voltage is smaller than a criterion value.
